(19) United States
(12) Patent Application Publication
(10) Pub. No.: US 2010/0059578 A1
(43) Pub. Date: Mar. 11, 2010

(54) PLANT CARRIER

(75) Inventor: John R. Widener, Haslett, MI (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: The John Henry Company, Lansing, MI (US)

(21) Appl. No.: 12/207,920

(22) Filed: Sep. 10, 2008

(51) Int. Cl. B65D 5/42; B32B 3/10; B65D 5/46

(52) U.S. Cl. 229/116.1; 428/131; 229/117.09

(57) ABSTRACT

A plant carrier includes a floor and sides with a cutout for holding a potted plant therein. The cutout in the sides defines an area for exposing the foliage of the plant and each side has a pair of upwardly extending spaced-apart arms terminating in a handle. The arms of one side interlock with the corresponding arms on the opposite side with a buckle lock. The floor of the carrier, in one embodiment, includes upwardly formed tabs for stabilizing the bottom of a pot inserted therein. The carrier is typically made of a water-resistant material, such as a polymeric material, for strength and durability. The sides may include decorative and/or information indicia printed thereon.

### BACKGROUND OF THE INVENTION

The present invention relates to a plant carrier and particularly to one for transporting live potted plants.

Transferring potted plants can be awkward and cumbersome. Typically, the plants are merchandised at the retail level in a rack or stand where they must be picked up by the edge of the pot and held in a cantilevered fashion with the thumb over the edge of the pot and the hand stabilizing the side of the pot. When two or more potted plants are selected, the process can become even more cumbersome. Such live plants are typically displayed in a group with plant stakes identifying the plant and its care instructions. Such stakes are shown, for example, in U.S. Pat. No. 7,076,900. Although such plant stakes identify the plant and the care instructions, they do not assist in the transportation and overall display of the potted plant. Thus, there exists a need for easier transportation of potted plants from both the nursery to the retailer and by the consumer from the retailer to the home or business environment.

### SUMMARY OF THE INVENTION

The plant carrier of the present invention solves this need by providing a purse-like plant carrier which includes a floor and sides with a cutout for holding a potted plant therein. The cutout in the sides defines an area for exposing the foliage of the plant and each side has a pair of upwardly extending arms terminating in a handle. The arms of one side interlock with the corresponding arms on the opposite side with a buckle lock. The floor of the carrier, in one embodiment, includes upwardly formed tabs for stabilizing the bottom of a pot inserted therein. The carrier, thus, captively holds a potted plant therein and provides a carrier handle for ease of transporting the potted plant to various locations. Further, the carrier provides a significant area upon which the plant identification and care information can be printed as well as providing a decorative display for the potted plant once transported to the environment in which the plant will remain. The carrier is typically made of a water-resistant material, such as a polymeric material, for strength and durability.

These and other features, objects and advantages of the present invention will become apparent upon reading the following description thereof together with reference to the accompanying drawings.

### BRIEF DESCRIPTION OF THE DRAWINGS

FIG. 1 is a front elevational view of a plant carrier of the present invention with a plant shown therein;

FIG. 2 is a plan view of the die cut form which is folded into the plant carrier;

FIG. 3 is a rear elevational view of the assembled plant carrier of the present invention;

FIG. 4 is a perspective view of a plant carrier shown holding a pot therein;

FIG. 5 is a fragmentary enlarged view of one of the buckle locks in the process of being folded to a locking position;

FIG. 6 is a fragmentary enlarged view of one of the buckle locks in the process of being inserted into a locking slot; and

FIG. 7 is an enlarged perspective view of the buckle lock for one of the arms shown in the locked position, as also seen in FIGS. 1, 3, and 4.

### DETAILED DESCRIPTION OF THE PREFERRED EMBODIMENT

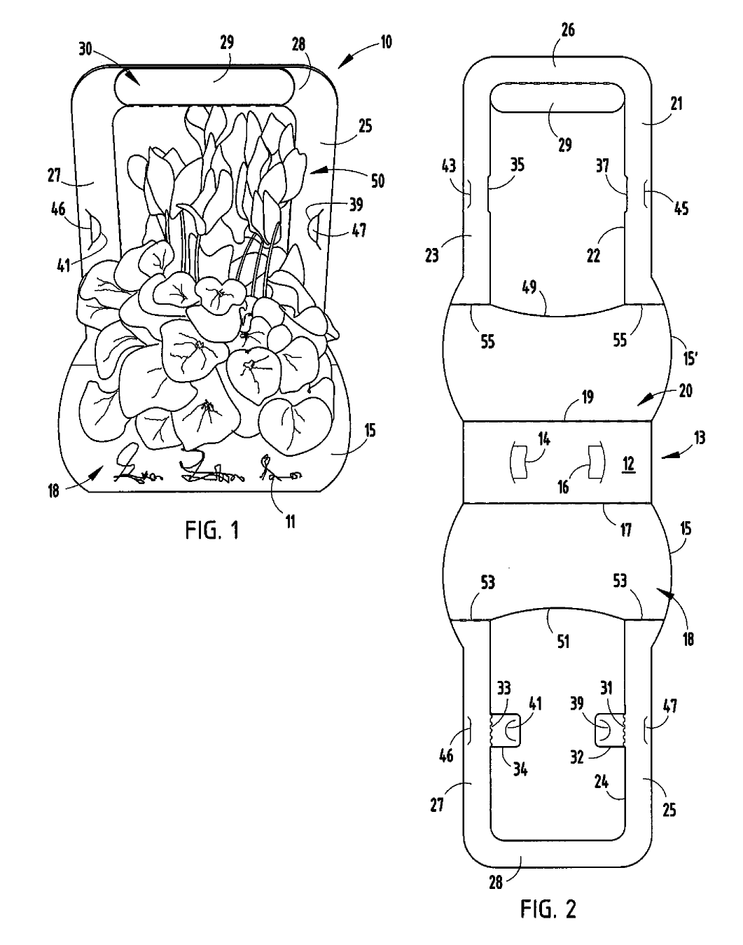

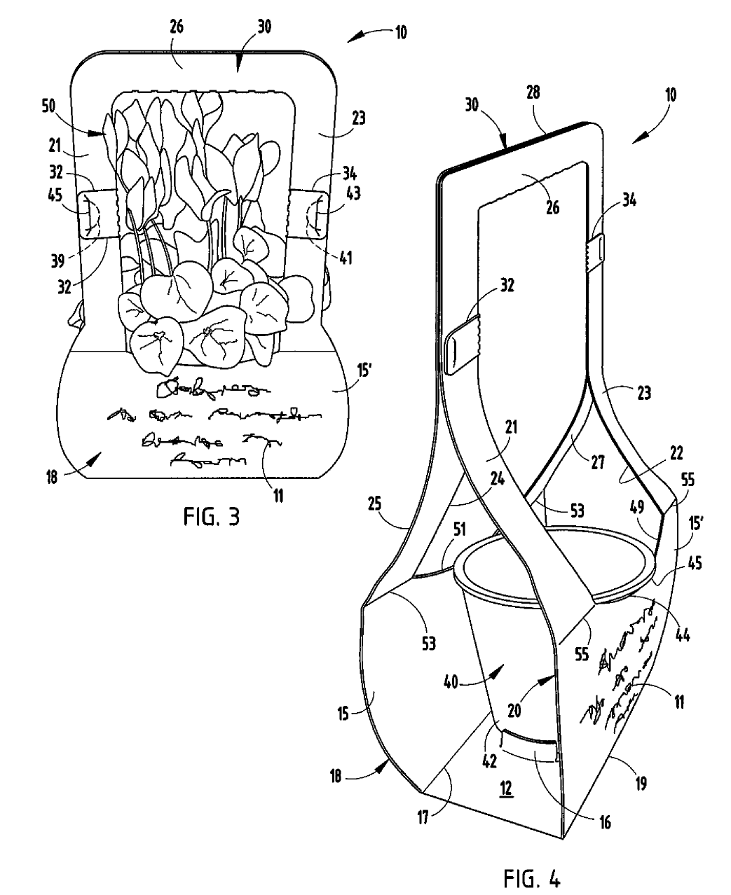

Referring initially to FIGS. 1, 3, and 4, there is shown a plant carrier 10 embodying the present invention, which is designed for holding a potted plant, such as plant 50 shown in FIGS. 1 and 3. The carrier 10 is initially made from a die cut form 13 (FIG. 2) of durable, water-resistant material, such as 18 to 22 point PVC or 18 to 22 point wet strength paperboard. The die cut form 13, defining the carrier 10 when folded, comprises a generally rectangular floor section 12 having a pair of spaced-apart arcuate die cut tabs 14 and 16 which are bent upwardly, as seen in FIG. 4, to engage and circumscribe the floor area 42 of pot 40 on opposite sides to stabilize the pot within the carrier.

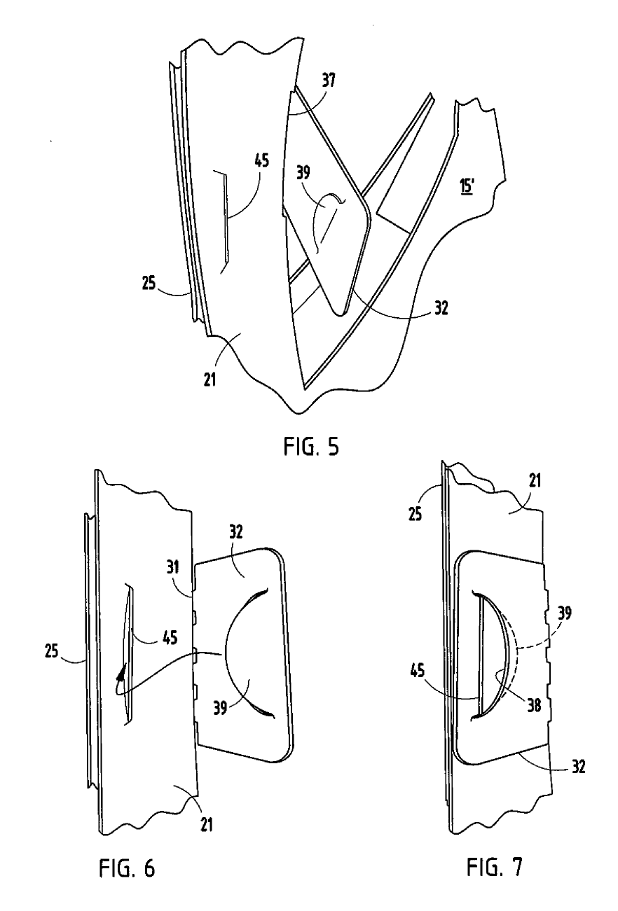

The carrier includes side walls 18 and 20, which are bent upwardly on seams 17 and 19 intersecting the floor 12 and for such purposes seams 17 and 19 are partially perforated to assist in the upward deflection of the side walls 18 and 20. Side walls 18 and 20 include a lower central body 15 and 15′ which are integrally coupled to arms 25 and 27 and 21 and 23, respectively, by fold lines 53 and 55, which can be deflected somewhat, as seen in FIG. 4, to facilitate the insertion of a plant pot 40 therein and the inward converging junction of the arms 21 and 25 and 23 and 27. The side walls 18, 20 each include a generally rectangular cutout 22 and 24, respectively, which define arms 21 and 23 and 25 and 27, respectively. The arms integrally terminate in cross members 26 and 28, respectively, defining a handle 30 for carrier 10. Cross member 28 includes a fold-over tab 29 which, when assembled, circumscribes cross member 26 to define the handle 30 (FIGS. 1 and 3) of carrier 10. Arms 21 and 25 are locked together as are corresponding arms 23 and 27 of the carrier by a buckle lock, as illustrated in FIGS. 5-7. The buckle lock comprises tabs 32 and 34 (FIG. 2) on arms 25 and 27, which project inwardly and are folded at fold lines 31 and 33, respectively, to the arms. When arms 21 and 25 and 23 and 27, respectively, are positioned adjacent and in contact with one another, tabs 32 and 34 are folded at fold lines 31 and 33 over rectangular slots 37 and 35 on the inner edge of arms 21 and 23 (FIGS. 2 and 5), respectively. Subsequently, arcuate locking tabs 39 and 41 on tabs 32 and 34, respectively, extend through slot 43 in arm 23 and slot 45 in arm 21. The locking tabs then extend through slot 46 in arm 27 adjacent arm 23 and slot 47 in arm 25 adjacent arm 21 to hold the respective arms in contesting relationship, which results in the completion of the purse-like carrier 10, as seen in FIGS. 1, 3 and 4. The carrier is particularly well adapted to hold a potted plant, such as cyclamen plant 50 shown in FIG. 1, therein for easy transportation by using the handle 30 defined by the carrier.

The buckle locks comprise, in a preferred embodiment, the tabs 32 and 34, the notches 35 and 37, the arcuate tabs 39 and 41 and the slots 43, 45, 47 and 46. The tabs 32, 34 on arms 25, 27 fold over the adjacent arms 21, 23 to securely attach arm 21 to arm 25 and arm 23 to arm 27. The interlocking of arms 21 and 25 is shown in FIGS. 5-7, where tab 32 is initially bent at line 31 to overlap slot 37 in arm 21, as seen in FIG. 5. The arcuate locking tab 39 of tab 32 is then projected outwardly and fits within slot 45 of arm 21. Slot 45 is aligned with slot 47 of arm 25 and the locking tab 39 is also extended through slot 47 of its own arm 25 to thereby buckle lock the two arms 21 and 25 together in locked engagement. The edge 38 of the slot defining tab 39 is seen in FIG. 7. The same buckling action secures arms 23 and 27 together upon assembly of the carrier 10 into the position shown in FIGS. 1, 3, and 4.

The outer surfaces of the carrier can be decorated with indicia 11 (FIGS. 1, 3, and 4) for a particular theme, such as Valentine's Day, Mother's Day, a birthday, Christmas, or other holidays and may include instructions for care of the plant contained therein. In the embodiment shown, the plant carrier 10 is specifically designed for a four-inch pot and, as such, the floor 12 is about 3 inches by 6¾ inches. The side walls have an overall height of about 13¼ inches, including the handles, arms and the 6 inch high base sections 15, 15′ of the sides, which are slightly convexly rounded, as seen in FIG. 1. The cutouts 22 and 24 have a width of about 4¾ inches and are about 8 inches tall to provide sufficient clearance for the foliage of plant 50 to extend outwardly and be displayed, as seen in FIGS. 1 and 3. The width of arms 21, 23, 25, and 27 is about 1 inch, as is the height of the handle section 26 and 28 an overlapping fold-over tab 29. Upwardly projecting arcuate tabs 14 and 16 are spaced apart a distance to securely grip the floor 42 of the pot 40, as illustrated in FIG. 4, with the rim 44 of the pot extending over the arcuate curved edges 49 and 51 of the cutouts 22 and 24.

The purse-like carrier 10 can be used not only to transport a potted plant 50 by the use of carrying handle 30 but also to decorate the pot 40 and display the plant 50 once moved to the environment in which the plant is to remain.

It will become apparent to those skilled in the art that the dimensions of carrier 10 can be varied for larger and smaller pots, which may require a different thickness of material. These and various other modifications to the preferred embodiment of the invention as described herein can be made without departing from the spirit or scope of the invention as defined by the appended claims.

The invention claimed is:

1. A pot carrier including:
a floor and pair of side walls extending upwardly from the floor;
wherein each of the side walls include a cutout defining upwardly extending spaced-apart arms and an integral cross member; and
a lock on each of said side walls for securing the facing aligned arms of said side walls together.

2. The pot carrier as defined in claim 1 wherein one of said side walls includes a tab at said cross member for overlapping said cross member of an adjacent side wall to hold said cross members together to define a handle.

3. The pot carrier as defined in claim 2 wherein said floor of said carrier includes a pair of spaced-apart upwardly extending tabs for engaging the lower sides of a pot positioned thereon.

4. The pot carrier as defined in claim 3 wherein said upwardly extending tabs are arcuate to partially circumscribe a pot placed in said carrier.

5. The pot carrier as defined in claim 4 wherein said lock comprises a first tab extending inwardly from one edge of an arm of one of the side walls and wherein said first tab includes a locking tab integrally formed therein and wherein the corresponding arm on the remaining side wall includes a slot in the edge thereof, allowing said first tab to extend thereover.

6. The pot carrier as defined in claim 5 wherein said lock further comprises a pair of aligned slots formed in corresponding arms of said side walls such that said locking tab can extend through both of said slots for interlocking corresponding aligned arms together.

7. The pot carrier as defined in claim 1 wherein said material comprises 18 to 22 point PVC.

8. The pot carrier as defined in claim 1 wherein said material comprises 18 to 22 point wet strength paperboard.

9. The pot carrier as defined in claim 1 wherein said pot carrier includes decorative indicia on the outer surface of at least one of said side walls.

10. A purse-shaped pot carrier comprising:
a pair of side walls having convexly curved outer edges;
a floor coupled between said side walls;
a pair of spaced-apart arms extending upwardly from said side walls and terminating in an integral cross member; and
a buckle lock on each of said side walls for securing said arms together.

11. The pot carrier as defined in claim 10 wherein one of said cross members includes a tab for overlapping an adjacent cross member to define a carrying handle.

12. The pot carrier as defined in claim 11 wherein said floor of said carrier includes a pair of spaced-apart upwardly extending tabs for engaging the lower edges of a pot positioned thereon.

13. The pot carrier as defined in claim 12 wherein said upwardly extending tabs are arcuate to partially circumscribe a pot placed in said carrier.

14. The pot carrier as defined in claim 13 wherein each of said buckle locks comprises a first tab extending inwardly from one edge of an arm of one of the side walls wherein said first tab includes a curved locking tab integrally formed therein and wherein the corresponding arm on the remaining side wall includes a slot in an edge thereof, allowing said first tab to extend thereover.

15. The pot carrier as defined in claim 14 wherein said buckle lock further comprises a pair of aligned slots formed in corresponding arms of said side walls such that said locking tab can extend through both of said slots for interlocking corresponding arms together.

16. The pot carrier as defined in claim 10 wherein said material comprises 18 to 22 point PVC.

17. The pot carrier as defined in claim 10 wherein said material comprises 18 to 22 point wet strength paperboard.

18. The pot carrier as defined in claim 10 wherein said pot carrier includes decorative indicia on the outer surface thereof.

19. A die cut form made of a polymeric or other water-resistant material which can be folded to form a purse-shaped pot carrier, said form comprising:
a generally rectangular floor section;
a pair of side walls integrally extending from opposite sides of said floor, wherein each of said side walls include a cutout for defining a pair of spaced-apart arms and integral cross handles;
a first tab on each of said arms of one of said side walls;
a locking tab on each of said first tabs; and
a slot on each of said arms aligned with said locking tab.

20. The form as defined in claim 19 wherein said floor section includes a pair of spaced-apart arcuate slots for defining upwardly extending tabs for engaging the lower edges of a pot positioned thereon.
